(19) United States
(12) Patent Application Publication
(10) Pub. No.: US 2023/0339698 A1
(43) Pub. Date: Oct. 26, 2023

(54) CONVEYOR ELEMENT AND CONVEYOR DEVICE

(71) Applicant: On Time Systems GmbH, Bielefeld (DE)

(72) Inventor: Ralf SCHNEUING, Bielefeld (DE)

(73) Assignee: On Time Systems GmbH, Bielefeld (DE)

(21) Appl. No.: 18/137,516

(22) Filed: Apr. 21, 2023

(30) Foreign Application Priority Data
Apr. 25, 2022 (DE) 10 2022 109 936.9

(51) Int. Cl. B65G 47/26; B65G 19/02

(52) U.S. Cl. CPC B65G 47/268; B65G 19/025

(57) ABSTRACT

A conveyor element for transporting goods with a hook element for suspension on a conveyor rail and a holder hanging on the hook element, on which holder one or more goods can be received, is formed in such a way that the hook element comprises a first hook and at least one second hook, between which at least one engagement opening is formed. This allows the conveyor element to be effectively conveyed and separated in a conveying direction along a conveyor rail via a pawl conveyor.

### CROSS REFERENCE TO RELATED APPLICATIONS

Applicant claims priority under 35 U.S.C. § 119 of German Application No. 10 2022 109 936.9 filed Apr. 25, 2022, the disclosure of which is incorporated by reference.

### BACKGROUND OF THE INVENTION

### 1. Field of the Invention

The present invention relates to a conveyor element for transporting goods, having a hook element for suspension on a conveyor rail and a holder hanging on the hook element, on which holder one or more goods can be received, and a conveyor device.

### 2. Description of the Related Art

US 2003/0006123 A1 discloses a conveyor device with a guide rail on which a plurality of pawls are driven in rotation. The pawls have a receptacle into which an upper hook of a clothes hanger can be inserted in order to move it along the guide rail. Such a conveyor has proven itself, but problems can arise when adjacent hangers are pushed on top of each other and get caught in each other, so that the conveyor comes to a standstill. Therefore, in these conveyors, the hangers are arranged at a predetermined stowage distance, which depends on the length of the pawl. The longer the pawl, the greater the fixed accumulation distance between the clothes hangers. By lengthening the pawls, the accumulation distance can be increased, but this also reduces the transport capacity.

EP 2620394 B1 discloses a conveyor system with carrier bags, in which carriers can be moved along a conveyor rail with a U-shaped cross-section, which roll with rollers on the inwardly projecting webs of the conveyor rail. The carrier bags are then suspended from the carrier at a suspension point and can be opened and closed by means of a mechanism. Spacers are provided on the conveyor rail to stop the carriers at a predetermined distance and to prevent adjacent bags from piling up. In the case of such a carrier with rollers, there is the problem that these are exposed to high mechanical loads, especially on downhill sections and at accumulation areas, and have to be replaced due to wear, which makes the operation of such a conveyor system costly. In addition, the control of the drivers along the accumulation sections with the spacers is complex.

### SUMMARY OF THE INVENTION

It is therefore the object of the present invention to create a conveyor element and a conveyor device that enable reliable spacing of the conveyor elements by simple mechanical means and ensure a high transport capacity.

This object is achieved according to the invention with a conveyor element for transporting goods comprises a hook element for hanging on a conveyor rail and a holder hanging on the hook element, on which holder one or more goods can be received, wherein the hook element comprises a first hook and at least one second hook, between which at least one engagement opening is formed.

This allows a pawl of a pawl conveyor to engage the engagement opening to move the hook element along a conveyor rail. By providing two spaced hooks, the accumulation distance of multiple conveyor elements along the conveyor rail is increased so that there is less accumulation pressure when multiple conveyor elements are arranged side by side along an accumulation path. At the same time, the length of a pawl of the pawl conveyor can be kept the same in an existing installation, which keeps the transport capacity high. In addition, the use of two hooks distributes a weight load on the bearing surface, which reduces wear and tear.

The distance between the first hook and the at least one second hook is preferably at least as long as the length of the receptacle of a pawl, so that the pawl lifts on the rear hook in the direction of movement, but securely grips the front hook. The tip of the pawl engages between the rear and front hooks.

Preferably, the at least one engagement opening is provided at the uppermost area of the hook element in the hanging position. This allows a pawl to engage between the two hooks from above. The distance between the first hook and the second hook in the conveying direction can be, for example, between 5 mm to 100 mm, in particular between 10 mm to 50 mm. This allows a pawl with a tip to engage between the two hooks and the stowage distance is extended correspondingly to the distance between the two hooks compared to a conveyor element with only a single hook.

For a stable design of the conveyor element, the first hook is preferably connected to the second hook at a free end, optionally via a separate connecting element or by an integral one-piece design. The first hook and the second hook can optionally be integrally formed with each other from a bent wire. The free ends of the wire can be fixed to a plastic body so that the opening between the two hooks is completely closed.

For effective handling of the conveyor element, the holder is hingedly connected to the hook element. In this case the holder can be connected to the hook element via a double joint that is rotatable in two axes. A first axis preferably extends horizontally and perpendicularly to the conveying direction, while a second axis extends vertically to enable movement of the holder on the hook element. Preferably, the holder is biased into an initial position by gravity in this case. For this purpose, corresponding guide surfaces can be provided on the hook element and the holder, so that when the holder is rotated about an axis, in particular the vertical axis, the holder is simultaneously lifted so that the holder rotates back to the starting position without the effect of force due to gravity and lowers itself in the process.

To prevent several adjacent conveyor elements from being inclined, the thickness of the hook element in the conveying direction is preferably essentially the same as the thickness of the holder. This allows several conveyor elements to be pushed together without them being inclined.

The holder preferably comprises a bracket. A projection can be formed on the holder, in particular on the bracket, on one side in the conveying direction and a receptacle for a projection of an adjacent holder on a side opposite to the conveying direction. Similarly, a receptacle can be provided on the holder on one side in the conveying direction and a projection can be provided on the side opposite the conveying direction, which can be inserted into a receptacle of an adjacent holder. This design enables adjacent conveyor elements to be centered and fixed to each other so that, after being pushed together, they can only be moved as a unit in different directions, in particular can only be pivoted around the conveyor rail as a unit. The projection on the holder can in this case be conical in order to achieve centring when pushed together.

The holder may be designed for transporting items of clothing and may only comprise a retaining bracket. Preferably, however, the holder also comprises a bag in which objects can be placed for transport. Such bags can be opened automatically via opening mechanisms and can transport different objects.

For a stable structure, a bolt made of metal can be provided on the hook element, from which the holder hangs. The holder can hang on the bolt via another connecting bolt, which are aligned at right angles to each other so that a rotary movement about two different axes is possible.

The hook element preferably comprises a body made of plastic to which the at least two hooks are fixed. A memory element can optionally be provided on the plastic body for identifying the hook element and the goods transported with the conveyor element.

According to the invention, a conveyor device with a conveyor rail and a pawl conveyor with a plurality of rotating pawls is also provided, wherein at least one conveyor element can be moved along the conveyor rail by means of the pawls. Such conveyors enable reliable transport and sorting of goods, wherein the pawl element is preferably movable along the conveyor rail with sliding surfaces to avoid wear of guide rollers. The individual conveyor elements can be easily separated via the engagement opening on the hook element.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a section of a conveyor device according to the invention with several conveyor elements in a conveyor view;

FIG. 2 shows a view of the conveyor of FIG. 1 along an accumulation section;

FIG. 3 shows a detailed view of the conveyor elements of FIG. 2;

FIGS. 4A-4D show several views of a conveyor element according to the invention;

FIGS. 5A-5F show multiple views of a hook element of the conveyor element;

FIG. 6 shows a view of a conveyor with an accumulation section; and

FIG. 7 shows a view of a modified conveyor device.

### DETAILED DESCRIPTION OF PREFERRED EMBODIMENTS

A conveyor 1 comprises a conveyor rail 2 along which a pawl conveyor 3 with a plurality of pawls 4 can be moved. The pawl conveyor 3 is driven in rotation and comprises pawls 4 which are pivotably mounted in order to move conveyor elements 5 hanging on the conveyor rail 2.

Each conveyor element 5 comprises a hook element 6 from which a holder 7 hangs. The holder 7 comprises a bracket from which hangs a bag 14 that can be opened via a swivelling opening element 15 in order to insert goods into or remove goods from the bag 14.

Each hook element 6 comprises a first hook 8 and a second hook 9, both of which are suspended from the conveyor rail 2 and between which an engagement opening 10 is provided. This distributes the weight load of the conveyor element 5 over two hooks 8 and 9.

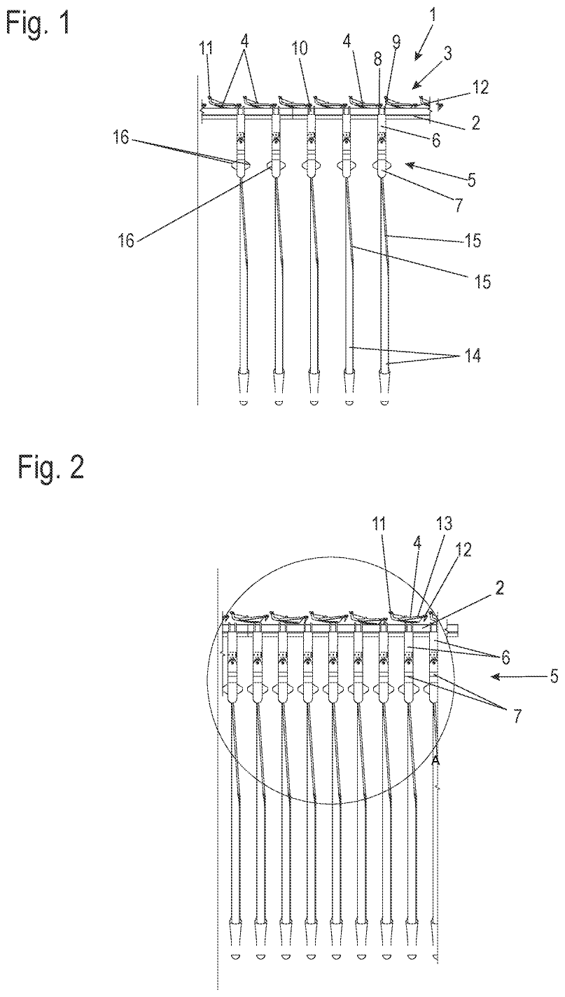

Each pawl 4 of the pawl conveyor 3 is mounted to pivot about a horizontal axis 11 and is guided, for example, on a chain or a cable. The pawl 4 rests from above on the conveyor rail 2 or on one of the hooks 8 or 9 and comprises a tip 12 at the end facing away from the axis 11 which can engage in the engagement opening 10 between the two hooks 8 and 9 in order to move the hook element 6 along the conveyor rail 2. FIG. 1 shows a transport position and the five conveyor elements 5 are each moved in the conveying direction by a pawl 4.

In FIG. 2, adjacent conveyor elements 5 are shown in an accumulated position, for example because the foremost conveyor element 5 is stopped in order to load or unload it. The conveyor elements 5 running onto the foremost conveyor element 5 are stopped because the pawl 4 is lifted during a movement along the conveyor rail 2 when it runs onto a rear hook 9 of a conveyor element 5. Then the tip 12 of the pawl 4 is lifted and the hook 8 is removed from a receptacle 13 between the tip 12 and the rest of the pawl 4, causing the conveyor element 5 to stop and the pawl 4 to move over other conveyor elements 5. When the accumulation is released, the respective foremost conveyor element 5 can be gripped by the front hook 8 via a pawl 4 and moved further along the conveyor rail 2.

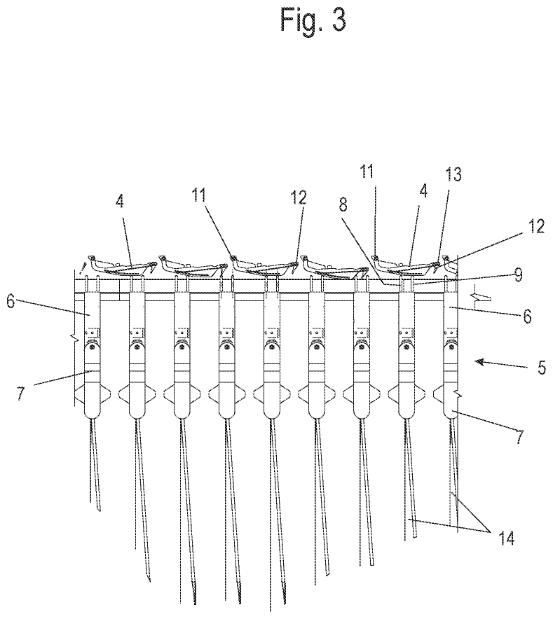

FIG. 3 shows the accumulated situation of FIG. 2 in detail. The distance between two adjacent conveyor elements 5 is determined by two parameters. On the one hand, the length of a pawl 4 in the conveying direction is decisive for the distance between two adjacent conveyor elements 5 in the accumulated situation. If the pawl 4 runs onto the hook 9 on the side of the axis 11, the tip 12 of the pawl 4 is lifted and thus disengages from the hook 8 of a conveyor element 5. In addition, the accumulation distance between adjacent conveyor elements 5 is increased compared to a conveyor element 5 with only a single hook by the fact that the hooks 8 and 9 are spaced apart. The receptacle 13 between the tip 12 and the body of the pawl 4 is dimensioned in such a way that only the front hook 8 in the conveying direction can be gripped by the tip 12 at any one time, while the pawl 4 is lifted when the rear hook 9 lifts the pawl 4, so that the stowage distance between two adjacent conveyor elements 5 is increased by the distance between the hooks 8 and 9. To achieve this accumulation distance between adjacent conveyor elements 5, the length of the pawls 4 would have to be increased, which reduces the transport capacity. Thus, by using two adjacent hooks, the accumulation distance can be increased while maintaining a high transport capacity.

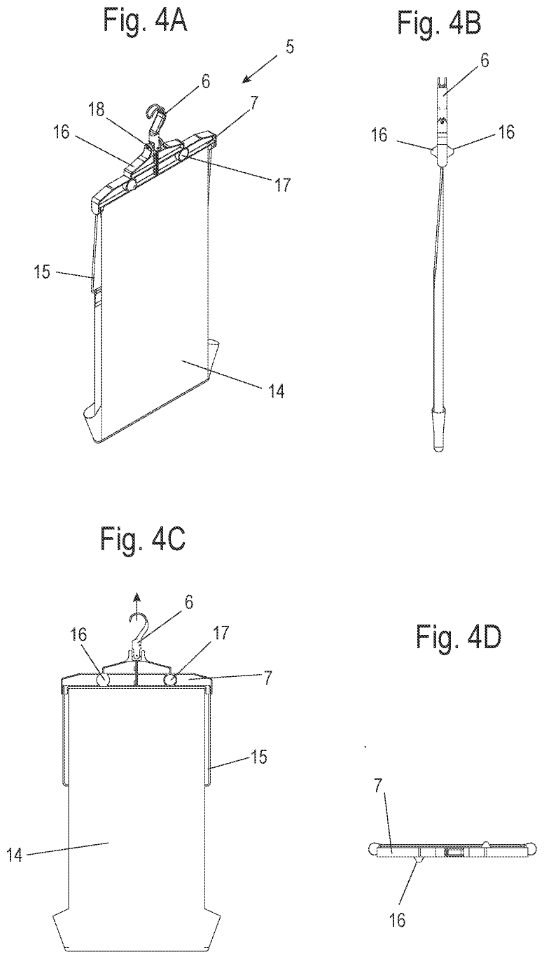

In FIGS. 4A-4D a conveyor element 5 is shown in detail. The conveyor element 5 comprises the upper hook element 6, on which the holder 7 is suspended. The holder 7 is held on the hook element 6 so that it is pivotable about two axes. The holder 7 comprises a bolt 18 which is inserted in a receptacle on the hook element 6 and via which a pivoting movement about an axis horizontally and perpendicularly to the conveying direction is made possible. In addition, the holder 7 can also be rotated by a certain angle around a vertical axis in order to be able to move the bag 14 flexibly on the holder 7. In particular, a certain compensating movement of the holder 7 with the bag 14 can take place along curves or when hitting obstacles.

The bracket-shaped holder 7 comprises a projection 16 in the conveying direction, which can be inserted into a recess or receptacle 17 of an adjacent holder 7. The holder 7 comprises a projection 16 both in the conveying direction and against the conveying direction, and receptacles 17 are formed on the holder 7 on the opposite side. The projections 16 and receptacles 17 are each tapered (shaped in form of a conical frustum) so that adjacent holders 7 are aligned when they are joined together. Other geometries of projections 16 and receptacles 17 can also be used and the positioning of the projections 16 and receptacles 17 can also be changed.

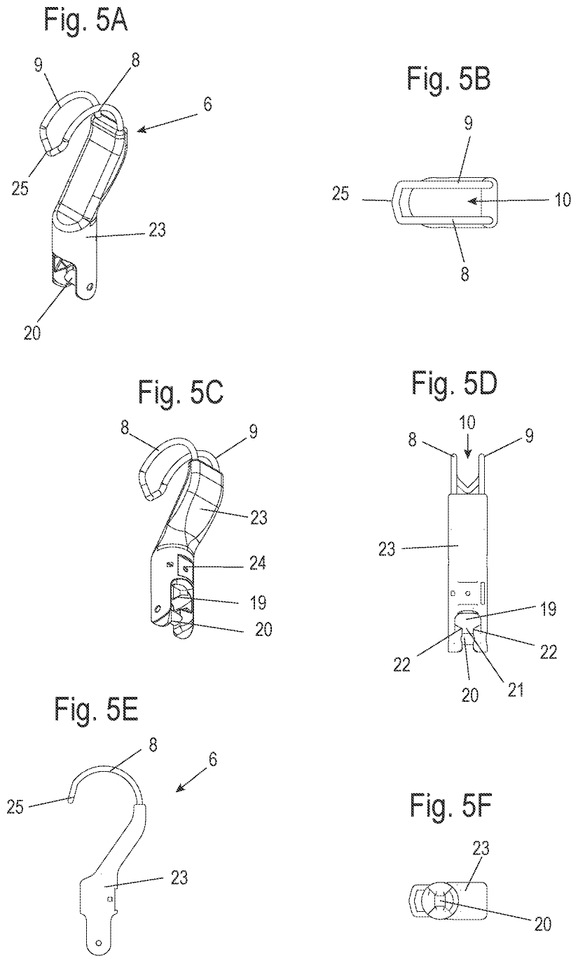

FIGS. 5A to 5F show a hook element 6 in detail. The hook element 6 comprises two spaced hooks 8 and 9 on an upper side, between which an engagement opening 10 is provided. The spacing of the hooks 8 and 9 can be in a range between 5 mm to 100 mm, in particular between 10 mm to 50 mm. The two hooks 8 and 9 are made of a bent wire and are connected to each other at their free end by a connection section 25. The hook element 6 further comprises a plastic body 23 in which the two ends of the bent wire and the hooks 8 and 9 are embedded. A receptacle 19 is provided on an underside of the plastic body 23, into which the bolt 18 of the holder 7 is insertable. Fixed to the receptacle 19 in the lower region is a bolt 20 which, in the assembled position, is aligned substantially parallel to the conveyor rail 2 and which, in conjunction with the bolt 18 on the holder 7, forms a double joint so that the holder 7 is pivotable about two axes relative to the hook element 6. The bolt 18 is arranged in the holder 19 such that the bolt 18 rests on the bolt 20 at a tapered section 21, as shown in FIG. 5D. The tapered section 21 is surrounded by two side walls 22 which spread upwards. When the bolt 18 rotates relative to the hook member 6 about a vertical axis, the bolt 18 is lifted with the holder 7 so that a force must be applied for the rotational movement.

Because of gravity and the formation of the side walls 22, the holder 7 is thus biased into an initial position in which the holder 7 is aligned substantially perpendicular to the conveyor rail. The bolts 18 and 20 may be made of metal in this case to ensure stable support of the goods in the bag 14.

The plastic body 23 further comprises a memory element 24 for identifying the conveyor element 5 and thus the goods transported therein. The memory element 24 can be designed as an RFID chip or other memory element.

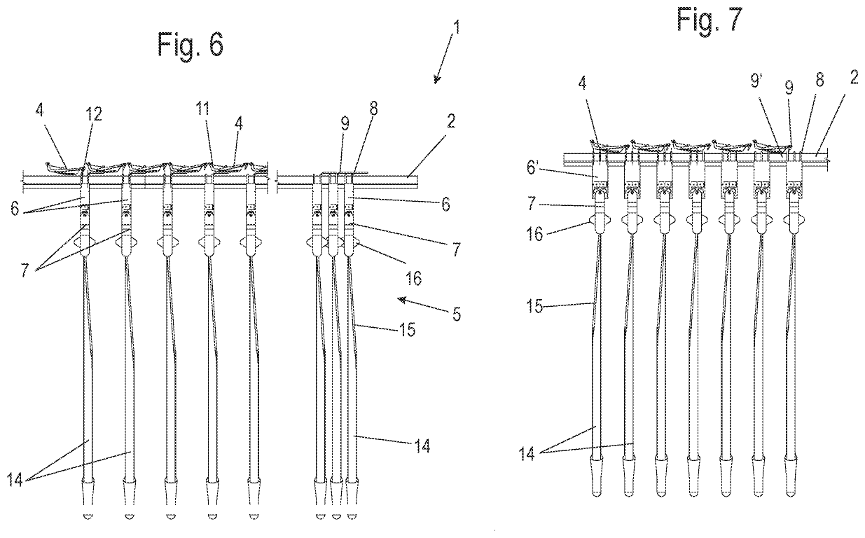

In FIG. 6, a storage position is shown on the right-hand side, in which several adjacent conveyor elements 5 are pushed into each other. It is also shown that by extending the hook element 6 with the rear hook, the accumulation distance along the conveyor rail 2 in the pawl conveyor is significantly increased. On the holder 7, the protruding projections 16 are each inserted into receptacles 17 of an adjacent conveyor element 5. This means that the conveyor elements 5 can only be swivelled together around the conveyor rail 2. The conveyor elements 5 can, for example, be brought to this minimum distance along a downward slope of the conveyor rail 2.

Even if the conveyor elements 5 are arranged at the minimum distance, the foremost conveyor element 5 in each case can be gripped by a pawl 4, which engages with its tip 12 in the engagement opening 10 between the two hooks 8 and 9 in order to separate it from the other conveyor elements 5.

FIG. 7 shows a modified embodiment of conveyor elements which essentially correspond to the previous embodiment example, but which comprise a modified hook element 6′. The hook element 6′ comprises on the upper side a first hook 8, a second hook 9 and a third hook 9′, which are each arranged at a distance from each other. A pawl 4 of the pawl conveyor 3 can only engage in an engagement opening in the front area between hook 8 and hook 9 to move the respective conveyor element 5 along the conveyor rail 2. Thus, instead of only two hooks 8 and 9, more hooks can be used on the upper side of the hook element 6′ to further increase the accumulation distance while maintaining the same short pawls. The transport capacity can be maximised with an optimised stowage distance.

In addition, depending on the required accumulation distance, the distance between the two hooks 8 and 9 can be changed and depending on the transport capacity, the length of the pawls 4 can be changed.

Although only a few embodiments of the present invention have been shown and described, it is to be understood that many changes and modifications may be made thereunto without departing from the spirit and scope of the invention.

### LIST OF REFERENCE SIGNS

1 Conveyor device
2 Conveyor rail
3 Pawl conveyor
4 Pawl
5 Conveyor element
6 Hook element
6′ Hook element
7 Holder
8 Hook
9 Hook
9′ Hook
10 Opening
11 Axis
12 Tip
13 Receptable
14 Bag
15 Opening element
16 Projection
17 Receptable
18 Bolt
19 Receptable
20 Bolt
21 Section
22 Side wall
23 Plastic body
24 Storage element
25 Connection section

What is claimed is:

1. A conveyor element for transporting goods, comprising: a hook element for suspension on a conveyor rail and a holder hanging on the hook element, the holder being configured for receiving one or more goods, wherein the hook element comprises a first hook and at least one second hook, and wherein at least one engagement opening is formed between the first hook and the at least one second hook.

2. The conveyor element according to claim 1, wherein the engagement opening is provided at an uppermost region of the hook element in a suspended position of the conveyor element.

3. The conveyor element according to claim 1, wherein a distance between the first hook and the at least one second hook in a conveying direction is between 5 mm and 100 mm.

4. The conveyor element according to claim 1, wherein the first hook is connected to the second hook at a free end.

5. The conveyor element according to claim 1, wherein the first hook and the second hook are formed integrally with each other from a bent wire.

6. The conveyor element according to claim 1, wherein the holder is hingedly connected to the hook element.

7. The conveyor element according to claim 6, wherein the holder is connected to the hook element via a double joint rotatable about two axes.

8. The conveyor element according to claim 6, wherein the holder is biased by gravity into an initial position.

9. The conveyor element according to claim 1, wherein a thickness of the hook element formed in a conveying direction is essentially equal to a thickness of the holder.

10. The conveyor element according to claim 1, wherein the holder comprises a bracket.

11. The conveyor element according to claim 1, wherein a projection is formed on the holder on one side in a conveying direction and a receptacle for a projection of an adjacent holder is formed on a side opposite the conveying direction.

12. The conveyor element according to claim 1, wherein a bag is held suspended from the holder.

13. The conveyor element according to claim 1, wherein a bolt is provided on the hook element, and wherein the holder hangs from the bolt.

14. The conveyor element according to claim 1, wherein the hook element comprises a body made of plastic on which a memory element for identifying the conveyor element is provided.

15. A conveyor device comprising a conveyor rail and a pawl conveyor with a plurality of pawls by means of which at least one conveyor element according to claim 1 can be moved along the conveyor rail.
